(19) United States
(12) Patent Application Publication
(10) Pub. No.: US 2015/0136781 A1
(43) Pub. Date: May 21, 2015

(54) ADJUSTABLE RE-SEALABLE POLYMERIC STORAGE BAG

(71) Applicant: Andrew Ginn, Park City, UT (US)

(72) Inventor: Andrew Ginn, Park City, UT (US)

(21) Appl. No.: 14/080,806

(22) Filed: Nov. 15, 2013

(51) Int. Cl. B65D 33/25; B65F 1/00

(52) U.S. Cl. CPC B65D 33/25; B65F 1/0006
USPC 220/495.06; 383/42; 383/64

(57) ABSTRACT

An adjustable, re-sealable polymeric bag for perishable food storage and non-perishable storage is disclosed. The adjustable bag comprises a traditional locking or re-sealing mechanism in addition to one or more thin bendable elements affixed to, or within, the rim of the adjustable bag such that the bag is held open when the bendable element(s) are bent or adjusted, and closed when the bendable elements are bent back to a planar configuration. These bendable elements are inserted into recesses defined by the bag or affixed directly to the interior or exterior of the bag.

### BACKGROUND OF THE INVENTION

1. Field of the Invention

This invention relates to re-sealable polymeric bags, and more particularly relates to re-sealable polymeric bags for freezing and food preservation.

2. Description of the Related Art

Ziploc® re-sealable polymeric bags for food preservation have been known in the art for several decades. Varied species of these storage bags are designed for preservation of sandwiches, vegetables, meats, and other perishables. Some of these bags are translucent while others are fabricated from colored materials, coming in various sizes and shapes of up to three feet in diameter, some with expandable bases. The sealing, zipping, or closure, mechanism on these bags has evolved over time, from a press-down seal, to zip-lock seals having a slider.

Competing re-sealable storage bags produced by manufacturers such as Glad®, Ziploc , Hefty® and S.C. Johnson® battle for market-share, collectively grossing more than $100 million in annual sales.

While there is demand for each of these bags on the market, each fail to fulfill a basic need on the part of users of the bags who attempt to fill the bags with perishables (or other effects) without assistance. That need is the need to affix the bag into an open configuration for inserting perishable with one hand while holding an edge of the bag with the other. Static electricity and the tendency of the panels of the polymeric bags to adhere together make loading the bags difficult without assistance from a second party.

There exists a need in the industry for re-sealable, polymeric bag which will stay in an open configuration set by the user of the bag, while also being durable and inexpensive to manufacture.

### SUMMARY OF THE INVENTION

From the foregoing discussion, it should be apparent that a need exists for a re-sealable polymeric bag. Beneficially, such a device would overcome many of the difficulties with prior art by providing a more functional apparatus to consumers and professionals which can be used when fatigued with a single hand.

The present invention has been developed in response to the present state of the art, and in particular, in response to the problems and needs in the art that have not yet been fully solved by currently available apparatii and methods. Accordingly, the present invention has been developed to provide a re-sealable, translucent polymeric storage bag comprising: two translucent flexible polymeric panels heat-sealed together at one or more edges; the panels defining an open mouth for accessing the bag; a closure mechanism circumscribing the mouth of the bag; and a bendable metallic element affixed to one of the panels of the bag forming the mouth, the metallic elements affixed to the panels within one inch of the mouth, the metallic elements circumscribing the mouth of the bag; wherein the metallic elements are bendable to form a shape such that the metallic elements can be bent to hold open the mouth of the bag.

The closure mechanism may comprise a slider. In some embodiments, the bag further comprises a second bendable metallic object affixed to one of the panel of the bag. In other embodiments, the metallic elements be bent to hold the bag in a closed configuration.

The mouth of the bag may be held open in toroidal configuration.

A second re-sealable, transparent polymeric storage bag is recited comprising: two transparent flexible polymeric panels affixed together at three edges; the panels defining an open mouth for accessing the bag; a closure mechanism circumscribing the mouth of the bag for re-sealing the bag after insertion of a perishable into the bag; and one or more bendable metallic element(s) affixed to one of the panels of the bag forming the mouth within one or more recesses defined by the panels, the metallic elements affixed to the panels within two inches of the mouth, the metallic elements traversing a width of the bag; wherein the metallic elements are bendable to form a shape such that the metallic elements can be bent to hold open the mouth of the bag.

The closure mechanism may comprise a slider. The metallic elements may be be bent to hold the bag in a closed configuration.

A third sealable, transparent polymeric storage bag is recited comprising: two transparent flexible polymeric panels affixed together; a re-sealable closure mechanism circumscribing the mouth of the bag for re-sealing the bag after insertion of a perishable food product into the bag; and a bendable metallic element affixed to one of the panels of the bag within a recess defined by the panel; wherein the metallic elements is bendable to form an annular shape such that the metallic element can be bent to hold open the mouth of the bag.

The metallic elements may be vinyl-coated for use in a microwave.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an elevational perspective view of an adjustable re-sealable polymeric storage bag in accordance with the present invention;

FIG. 2 is a lower elevational perspective view of an adjustable re-sealable polymeric storage bag in accordance with the present invention;

FIG. 3 is an elevational perspective view of an adjustable re-sealable polymeric storage bag in accordance with the present invention; and

FIG. 4 is an elevational perspective view of an adjustable re-sealable polymeric storage bag in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

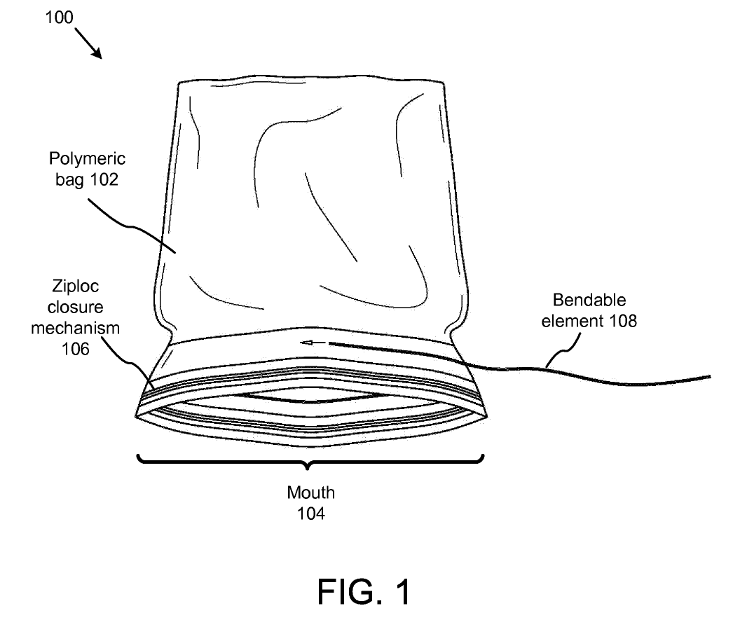

FIG. 1 is an elevational perspective view of an adjustable re-sealable polymeric storage bag 100 in accordance with the present invention. The adjustable bag 100 comprises a polymeric sack 102, a mouth 104, a closure mechanism 106, and an adjustable element 108.

The polymeric sack 102 has a top panel and lower panel, which are heat-sealed together. The panels define the mouth 104, which is circumscribed by the closure mechanism 106 such that the closure mechanism 106 can be used to seal, lock or zip the bag shut and open.

The closure mechanism 106 may comprise any one of a number of re-sealing mechanisms known to those in the art, including mechanisms having sliders.

The top panel of the present invention defines a recess which has received the bendable element 108.

The bendable element 108 is bendable, or adjustable, such that the mouth 104 of the bag 100 within which the bendable element 108 rests conforms to the shape of the bendable element 108. In this manner, a single operator of the bag 100 can adjust the bag 100 to stay in an open configuration while loading food perishables into the bag 100.

The bendable element 108 may be metallic, metal alloy, or made from any of a number of polymeric materials, including fiberglass and nylong.

The adjustable bag 100 is transparent or translucent so that its contents can be seen.

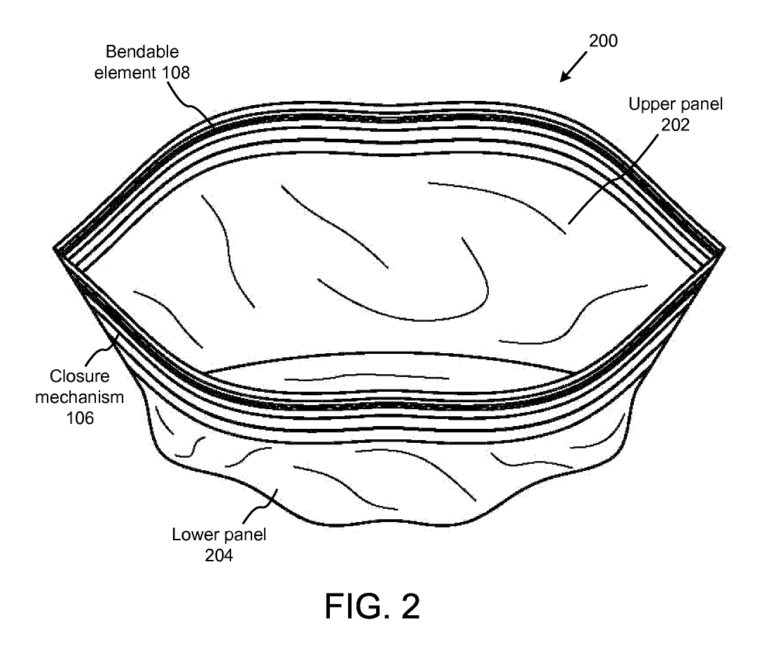

FIG. 2 is a lower elevational perspective view of an adjustable re-sealable polymeric storage bag 200 in accordance with the present invention. The adjustable bag 200 comprises an upper panel 202 and a lower panel 204, as well as a closure mechanism 106 and a bendable element 108.

In the shown embodiment, the bendable element 108 affixed to the upper panel 202 is bent in convex fashion to hold the upper panel 204 in an open configuration. The bendable element 108 affixed to the lower panel 204 is also bent, in concave configuration, to further serve to hold the bag 200 in an open configuration.

The bendable element 108 may be vinyl-coated for use in a microwave, or otherwise constructed for safe use in microwaves. The bendable element 108 may be coated in any material creating a microwave-safe environment.

Once perishable food storage has been loaded into the bag 200, the bendable elements 108 are rebent back into planar position and the bag 200 is re-sealed using the closure mechanism 106.

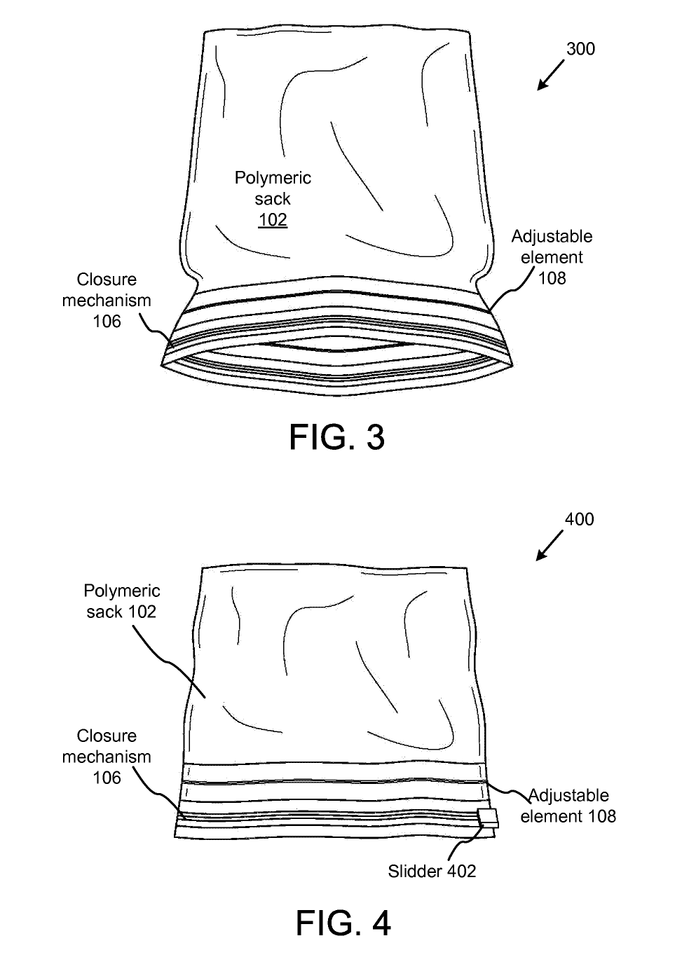

FIG. 3 is an elevational perspective view of an adjustable re-sealable polymeric storage bag 300 in accordance with the present invention. The adjustable bag 300 comprises a polymeric sack 102, a closure mechanism 106, and an adjustable element 108.

In various embodiments of the present invention, the adjustable element(s) 108 may be disposed in front or behind the closure mechanism 106 (meaning closer to the mouth 104 or further away from the mouth 104 than the closure mechanism 106).

In some embodiments, the adjustable element 108 is affixed to the outer edge of the panel 202.

FIG. 4 is an elevational perspective view of an adjustable re-sealable polymeric storage bag 400 in accordance with the present invention. The adjustable bag 400 comprises a polymeric sack 102, a closure mechanism 106, an adjustable element 108, and a slider 402.

FIG. 4 is meant to show that different types of closure mechanisms 106 may be incorporated into the present invention.

In various embodiments of the present invention, the polymeric bag comprises a garbage bag or other larger-sized multipurpose polymeric bag.

The adjustable element 108 may be affixed, in some embodiments, anywhere interiorly within the bag. In various embodiments, the adjustable element 108 is affixed to the exterior of the bag using adhesives or other means known to those of skill in the art.

The adjustable element 108 may be inserted into a recess defined by the sack 102, or interiorly or exteriorly to the sack 102. In some embodiments, the adjustable element 108 abuts the mouth or rim of the sack 102.

The bag 400 may be designed for storing perishable, non-perishables, waste, personal effects, or any other purpose. The bag may be any size, including sizes large enough for leaves and infitting dumpsters, including garbage bags and debris bags (bags used for leaves, litter and/or other debris collected from the ground).

The present invention may also be applied to sandwich bags and/or bags containing perishables sold by fast food restaurants or other commercial enterprises.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A re-sealable, translucent polymeric storage bag comprising:
two translucent flexible polymeric panels heat-sealed together at one or more edges; the panels defining an open mouth for accessing the bag;
a closure mechanism circumscribing the mouth of the bag; and
a bendable metallic vinyl-coated element affixed to one of the panels of the bag forming the mouth, the metallic elements affixed to the panels within one inch of the mouth, the metallic elements circumscribing the mouth of the bag;
wherein the metallic elements are bendable to form a shape such that the metallic elements can be bent to hold open the mouth of the bag.

2. The bag of claim 1, wherein the closure mechanism comprises a slider.

3. The bag of claim 1, further comprising a second bendable metallic object affixed to one of the panel of the bag.

4. The bag of claim 1, wherein the metallic elements be bent to hold the bag in a closed configuration.

5. The bag of claim 1, wherein the mouth of the bag is held open in toroidal configuration.

6. The bag of claim 1, wherein the metallic element is vinyl-coated for use in a microwave.

7. A re-sealable, transparent polymeric storage bag comprising:
a transparent bag defining an open mouth for accessing the bag;
a closure mechanism circumscribing the mouth of the bag for re-sealing the bag after insertion of a perishable into the bag; and
one or more bendable metallic element(s) affixed to one of the panels of the bag forming the mouth within one or more recesses defined by the panels, the metallic elements affixed to the panels within two inches of the mouth, the metallic elements traversing a width of the bag;
wherein the metallic elements are bendable to form a shape such that the metallic elements can be bent to hold open the mouth of the bag.

8. The bag of claim 7, wherein the closure mechanism comprises a slider.

9. The bag of claim 7, wherein the metallic elements be bent to hold the bag in a closed configuration.

10. The bag of claim 7, wherein the metallic elements are vinyl-coated for use in a microwave.

11. A sealable, transparent storage bag comprising:
two transparent flexible polymeric panels affixed together;
a re-sealable closure mechanism circumscribing the mouth of the bag for re-sealing the bag after insertion of a perishable food product into the bag; and
a bendable polymeric element affixed to one of the panels of the bag within a recess defined by the panel;
wherein the metallic elements is bendable to form an annular shape such that the metallic element can be bent to hold open the mouth of the bag.

12. The bag of claim 11, wherein the bag comprises one of a garbage bag and a debris bag.

13. The bag of claim 11, wherein the bag is used for storage of perishable food items.

14. The bag of claim 11, wherein the bag is used for storage of non-perishable items.
